(19) United States
(12) Patent Application Publication
(10) Pub. No.: US 2012/0072777 A1
(43) Pub. Date: Mar. 22, 2012

(54) DEBUGGING DEVICE, DEBUGGING METHOD, AND COMPUTER PROGRAM FOR SEQUENCE PROGRAM

(75) Inventor: Makoto Nonomura, Aichi (JP)

(73) Assignee: MITSUBISHI ELECTRIC CORPORATION, Chiyoda-ku, Tokyo (JP)

(21) Appl. No.: 13/322,501

(22) PCT Filed: May 27, 2009
(86) PCT No.: PCT/JP2009/059709

§ 371 Date: Nov. 25, 2011

(51) Int. Cl. G06F 11/36

(52) U.S. Cl. 714/38.1; 714/E11.212

(57) ABSTRACT

To provide a debugging device for a sequence program that provides a debugging environment in which debugging of a sequence program can be executed easily and efficiently. A range setting unit that sets a skipping range to be skipped when a sequence program is executed; an extracting unit that extracts an output contact that is included in the skipping range, and that outputs a value to another range; and a value setting unit that sets a value to the extracted output contact are included.

### FIELD

The present invention relates to a debugging device, a debugging method, and a computer program to improve debugging efficiency of a sequence program.

### BACKGROUND

Conventionally, when debugging of a sequence program is executed, a part of the sequence program is sometimes skipped to be executed. This is practiced when a part of an apparatus that is controlled by the sequence program is not completed, or the like. For example, Japanese Patent Application Laid-open No. H08-328614 (Patent Literature 1) discloses the invention of a programmable controller that skips a part of a program by specifying step No. of a range to be skipped.

In a debugging device for a sequence program disclosed in Patent Literature 1 and the like, a part of a sequence program is specified, settings to skip the specified range is done, and the sequence program is executed skipping the part according to the settings.

### CITATION LIST

### Patent Literature

Patent Literature 1: Japanese Patent Application Laid-open No. H08-328614

### SUMMARY

### Technical Problem

However, in the invention such as the programmable controller disclosed in Patent Literature 1 and the like, when debugging of a sequence program is executed, an operation result in a skipping range is simulatively set by using a function such as device test at the time of executing the sequence program, and therefore, there has been a problem that debugging is inefficient and difficult.

The present invention is achieved to solve these problems in view of the above, and it is an object of the present invention to provide a debugging environment that enables to execute debugging of a sequence program easily and efficiently.

### Solution to Problem

To achieve the above object, a debugging device for a sequence program according to the present invention applies a configuration as follows.

According to an aspect of the present invention, a debugging device for a sequence program, includes a range setting unit that sets a skipping range to be skipped when a sequence program is executed, an extracting unit that extracts an output contact that is included in the skipping range, and that outputs a value to another range, and a value setting unit that sets a value to the extracted output contact.

This enables to provide a debugging device for a sequence program that provides a debugging environment in which debugging of a sequence program can be executed easily and efficiently.

### Advantageous Effects of Invention

According to a debugging device, a debugging method, and a computer program for a sequence program of the present invention, it is possible to provide a debugging device, a debugging method, and a computer program for a sequence program that can provide a debugging environment in which debugging of a sequence program can be executed easily and efficiently.

### BRIEF DESCRIPTION OF DRAWINGS

FIG. 1 is a schematic diagram showing an example of a functional configuration of a debugging device according to a present embodiment.

FIG. 2-1 illustrates an example of a screen in which a part of a ladder program is displayed.

FIG. 2-2 is a view illustrating an example of a screen to set a skipping range.

FIG. 3-1 is a view for explaining a bit device and a word device that output values to a range out of the skipping range.

FIG. 3-2 is a view illustrating an example of a screen to set values of the bit device and the word device by a device test function.

FIG. 4 is a view for explaining one operated out of the skipping range and a value of which is referred in the skipping range.

FIG. 5 is a flowchart for explaining process of setting values to a bit device and a word device included in the skipping range.

FIG. 6-1 is a view illustrating an example of a screen in which a skipping range is specified for a ladder program.

FIG. 6-2 is a view illustrating an example of a screen that displays information regarding the skipping range.

FIG. 6-3 is a view illustrating a screen to set a value to a bit device and a word device referred in another range.

FIG. 7-1 is a view for explaining a screen in which a bit device that is operated in the skipping range is extracted.

FIG. 7-2 is a view illustrating a screen to set a value to the extracted bit device.

FIG. 8-1 is a view for explaining a screen in which a word device that is operated in the skipping range is extracted.

FIG. 8-2 is a view illustrating a screen to set a value to the extracted word device.

FIG. 9 is a flowchart for explaining process of setting a value to a bit device and a word device that are included in the skipping range and values of which vary according to a value of a bit device or a word device in another range.

FIG. 10-1 is a view illustrating an example (part 1) that a bit device that is operated in another range and is referred in the skipping range is extracted.

FIG. 10-2 is a view illustrating an example (part 1) that a bit device that is operated in the skipping range and is referred in another range is extracted.

FIG. 10-3 is a view illustrating an example (part 1) that a value of a bit device that is operated in the skipping range and is referred in another range is set.

FIG. 11-1 is a view illustrating an example (part 1) that a word device that is operated in another range and is referred in the skipping range is extracted.

FIG. 11-2 is a view illustrating an example (part 1) that a word device that is operated in the skipping range and is referred in another range is extracted.

FIG. 11-3 is a view illustrating an example (part 1) that a value of a word device that is operated in the skipping range and is referred in another range is set.

FIG. 12-1 is a view illustrating an example (part 2) that a bit device that is operated in another range and is referred in the skipping range is extracted.

FIG. 12-2 is a view illustrating an example (part 2) that a word device that is operated in the skipping range and is referred in another range is extracted.

FIG. 12-3 is a view illustrating an example (part 2) that a value of a word device that is operated in the skipping range and is referred in another range is set.

FIG. 13-1 is a view illustrating an example (part 2) that a word device that is operated in another range and is referred in the skipping range is extracted.

FIG. 13-2 is a view illustrating an example (part 2) that a bit device that is operated in the skipping range and is referred in another range is extracted.

FIG. 13-3 is a view illustrating an example (part 2) that a value of a bit device that is operated in the skipping range and is referred in another range is set.

FIG. 14 is a schematic diagram of a hardware configuration of a debugging device 10 according to the present embodiment.

### DESCRIPTION OF EMBODIMENTS

Hereinafter, the present embodiment is explained with reference to the drawings. Although in the embodiment below, explanation is given mainly for ladder programs, the embodiment can also be applied to debugging of a sequence program such as structured text, function block diagram, or sequential function chart, not limited to ladder programs. Moreover, “input contact” in the embodiment below corresponds to “contact” in, for example, ladder programs, and “output contact” corresponds to “coil” in, for example, ladder programs.

### Present Embodiment

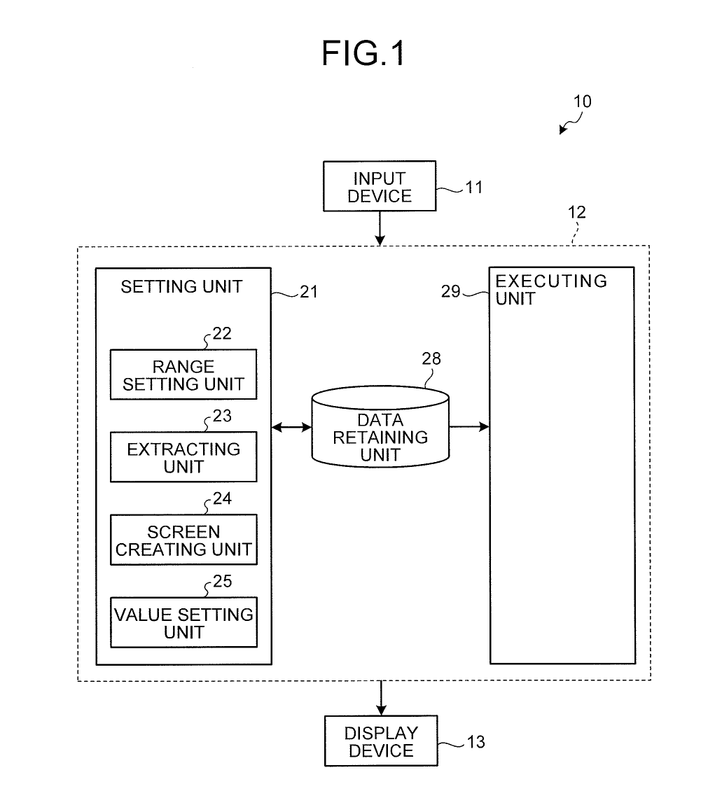

FIG. 1 is a schematic diagram showing an example of a functional configuration of a debugging device according to the present embodiment. A debugging device 10 shown in FIG. 1 includes an input device 11, a control unit 12, and a display device 13. The input device 11 is input equipment such as a keyboard, for example, and an instruction for debugging processing and the like are input therethrough by an operator. From the input device 11, a range to be skipped in a sequence program is also input. The display device 13 is, for example, a display and the like, and a sequence program to be executed at debugging, results of debugging, and the like are displayed thereon.

The control unit 12 performs debugging processing for a sequence program. The control unit 12 includes a setting unit 21, a data retaining unit 28, and an executing unit 29. The setting unit 21 sets a range to be skipped when a sequence program is debugged, and sets a value of a contact of the range. The setting unit 21 includes a range setting unit 22, an extracting unit 23, a screen creating unit 24, and a value setting unit 25.

The range setting unit 22 sets a skipping range to be skipped when a sequence program is executed. Note that “to be skipped” means to proceed to a following line or the like without executing a specified range or the like.

The extracting unit 23 extracts an output contact that outputs a value to another range of the sequence program from among contacts included in the set skipping range. The extracting unit 23 also extracts an input contact that inputs a value to the skipping range from among contacts included in a range different from the set skipping range.

The screen creating unit 24 creates a screen to urge setting of a skipping range and a screen that displays information regarding a skipping range, information regarding a contact, information regarding a value set to a contact, and the like.

The value setting unit 25 sets a value to the output contact extracted by the extracting unit 23. The value setting unit 25 also sets a value of an output contact for each input contact when values of output contacts differ for respective values of input contacts.

The data retaining unit 28 retains the value of the output contact set by the value setting unit 25. The data retaining unit 28 also retains the information regarding a skipping range set by the range setting unit 22.

The executing unit 29 executes debugging processing for a sequence program. The executing unit 29 acquires information regarding a skipping range, at debugging, from the data retaining unit 28. The executing unit 29 also acquires a value of an output contact that outputs a value from the skipping range, from the data retaining unit 28. Thus, debugging can be executed skipping a part of a sequence program, without using a device test function or the like at the time of debugging processing.

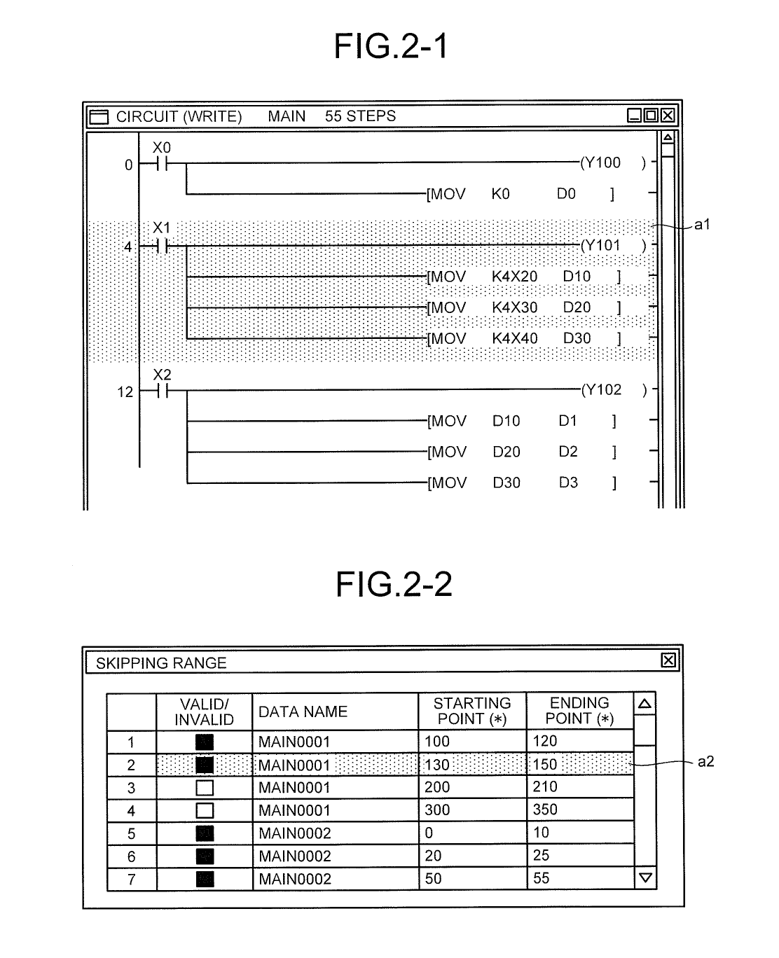

Before detailed explanation of the debugging processing by the debugging device 10 according to the present embodiment, an overview of a conventional debugging processing is explained using FIGS. 2 to 4. FIGS. 2 to 4 are views for explaining an example of a screen that is displayed when the debugging processing for a sequence program is executed. FIG. 2-1 illustrates an example of a screen in which a part of a ladder program is displayed. In the screen shown in FIG. 2-1, a hatched range al is the skipping range. Specification of a skipping range may be performed by specifying a step in the screen shown in FIG. 2-1 by using input equipment such as a mouse, for example.

FIG. 2-2 illustrates an example of a screen to set the range al shown in FIG. 2-1 as a skipping range. In the example shown in FIG. 2-2, a hatched line a2 is set as the skipping range.

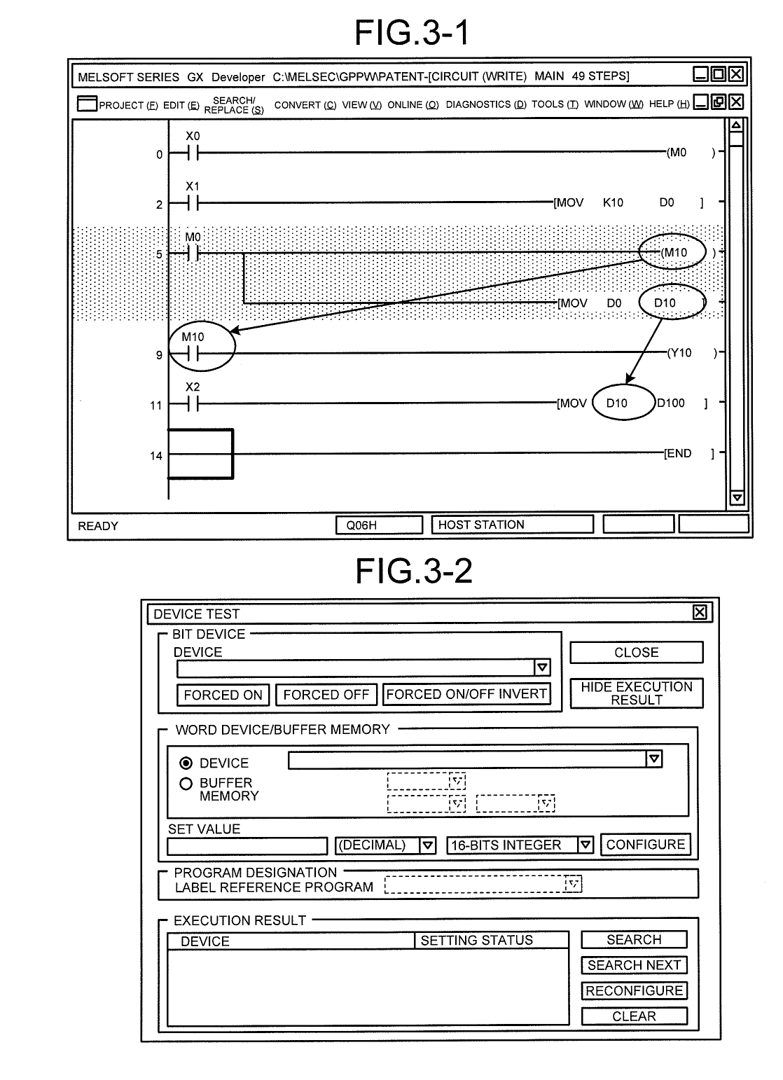

FIG. 3-1 is a view for explaining a bit device and a word device that output values to a range out of the skipping range among bit devices and word devices included in the skipping range. In the example shown in FIG. 3-1, a bit device M10 and a word device D10 are referred out of the skipping range. Therefore, a value obtained by operation in the skipping range is simulatively set by a device test function. FIG. 3-2 is a view illustrating an example of a screen to set a value of the bit device and the word device by a device test function at the debbuging processing.

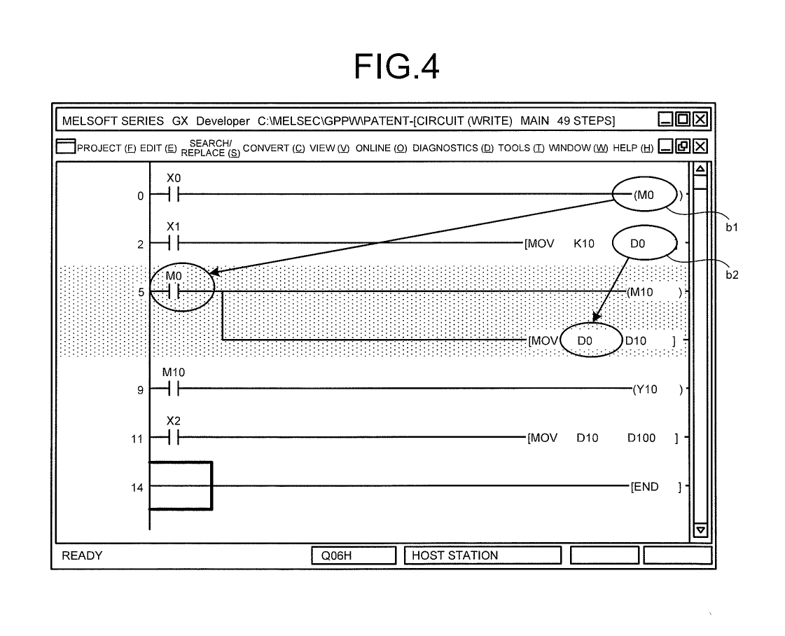

FIG. 4 is a view for explaining one that is operated out of the skipping range and a value of which is referred in the skipping range among a bit device and a word device included in the skipping range. In the example shown in FIG. 4, the bit device M10 and the word device D10 are the ones whose values are determined by operation on a line b1 and a line b2, respectively, out of the skipping range. For these bit device and word device also, values thereof are simulatively set by the device test function.

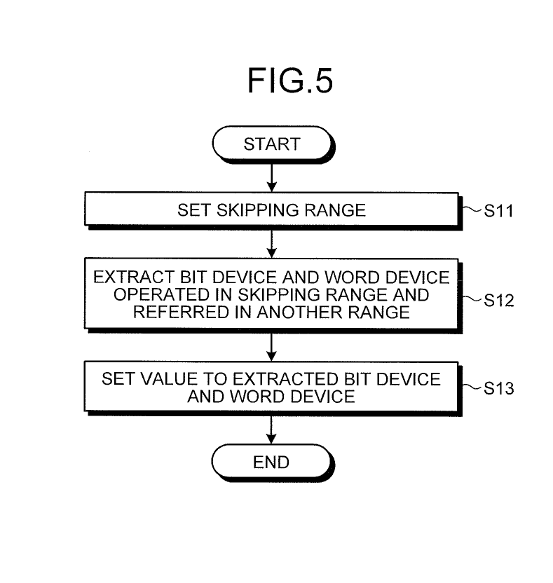

FIG. 5 is a flowchart for explaining process of setting values to a bit device and a word device included in the skipping range performed by the debugging device 10. At step S11 in FIG. 5, the range setting unit 22 sets a skipping range. Proceeding from step S11 to step S12, the extracting unit 23 extracts a bit device and a word device that are operated in the skipping range and are referred in another range.

Proceeding from step S12 to step S13, the value setting unit 25 sets values to the bit device and the word device extracted at step S12.

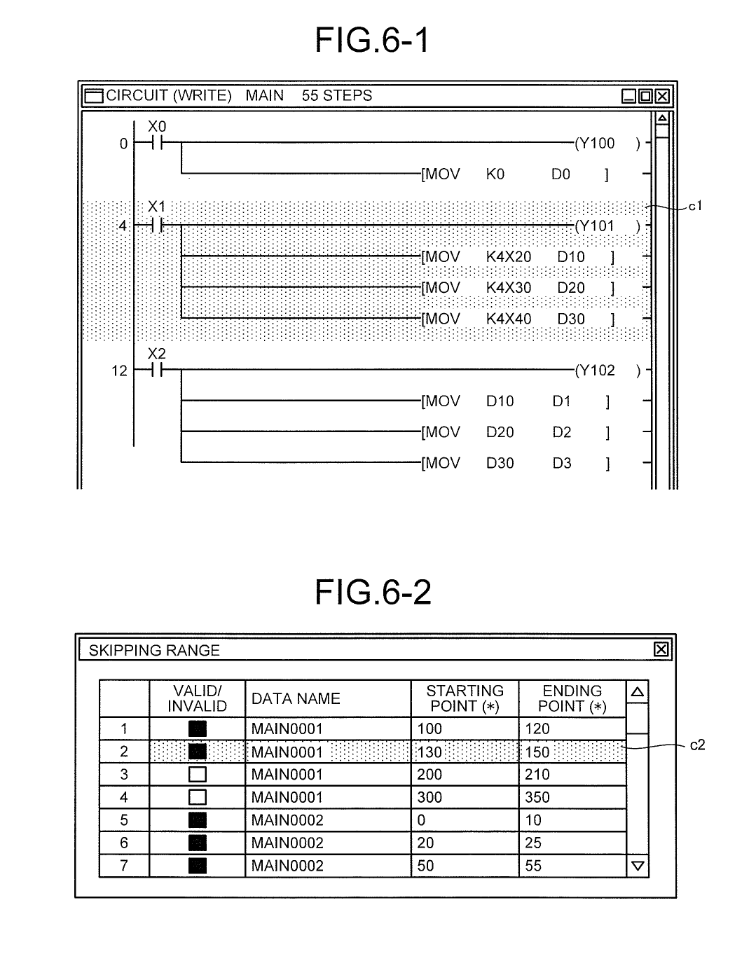

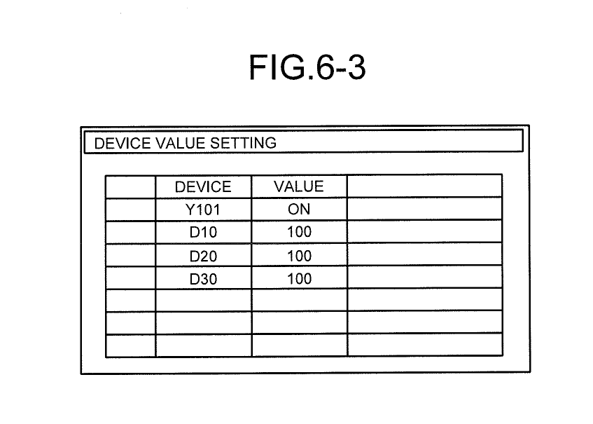

FIG. 6 is a view illustrating an example of a screen displayed in the processing shown in FIG. 5. The screen shown in FIG. 6 is displayed on the display device 13. FIG. 6-1 is a view illustrating an example of a screen in which a skipping range is specified for a ladder program. In the example shown in FIG. 6-1, a hatched range c1 is specified as the skipping range. FIG. 6-2 is a view illustrating an example of a screen that displays information regarding the specified skipping range c1. In the example shown in FIG. 6-2, a line c2 indicating the starting point and the ending point of the skipping range c1 is emphasized.

FIG. 6-3 is a view illustrating a screen to set values to a bit device and a word device that are referred in another range among bit devices and word devices that are operated in the skipping range c1. In the example shown in FIG. 6-3, value “ON” is set to the word device M10, and value “100” is set to the bit device D10. By inputting a value from the input device 11 by an operator based on the screen shown in FIG. 6-3, the value is set for a corresponding bit device or word device.

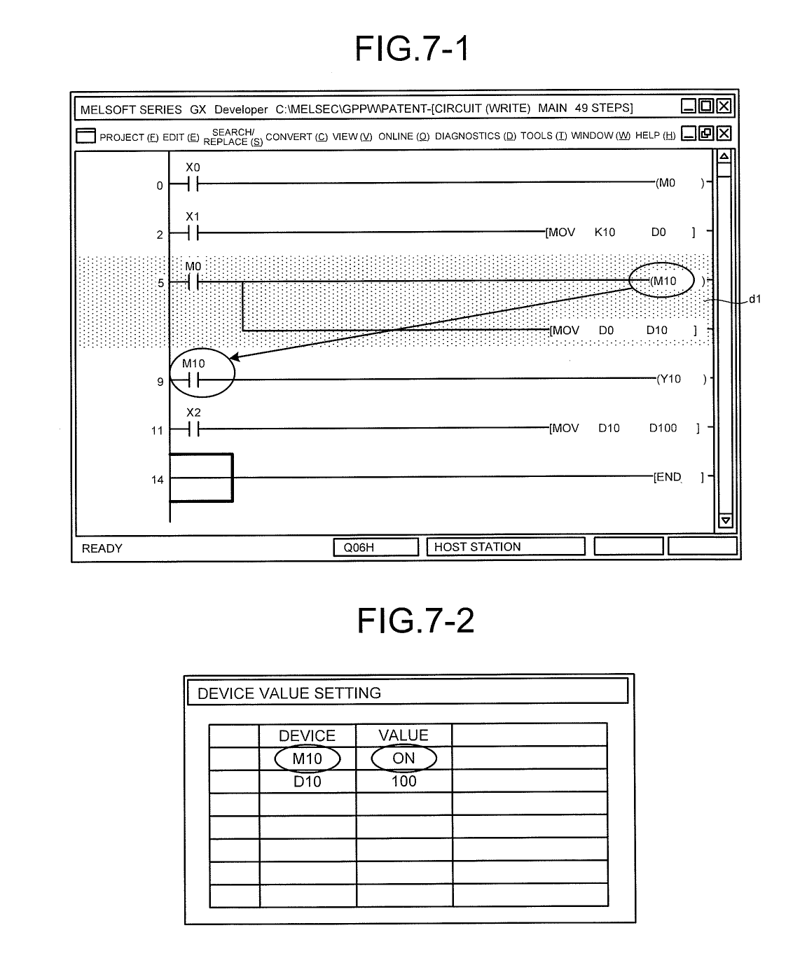

FIG. 7 is a view for explaining a screen when a bit device that is operated in the skipping range is extracted and a value is set therefor. Screens shown in FIGS. 7-1 and FIG. 7-2 are created by the screen creating unit 24 and are displayed on the display device 13. In the example shown in FIG. 7-1, the bit device M10 is included in a skipping range d1, and the bit device M10 is referred out of the skipping range d1. Thus, the extracting unit 23 extracts the bit device M10.

FIG. 7-2 is a view illustrating a screen to set a value to the extracted bit device M10. In the example shown in FIG. 7-2, value “ON” is associated with the bit device M10. “M10” in an item of device is the bit device extracted by the extracting unit 23, and the value input from the input device 11 is displayed in a corresponding value section. Thus, the value setting unit 25 sets value “ON” to the bit device M10.

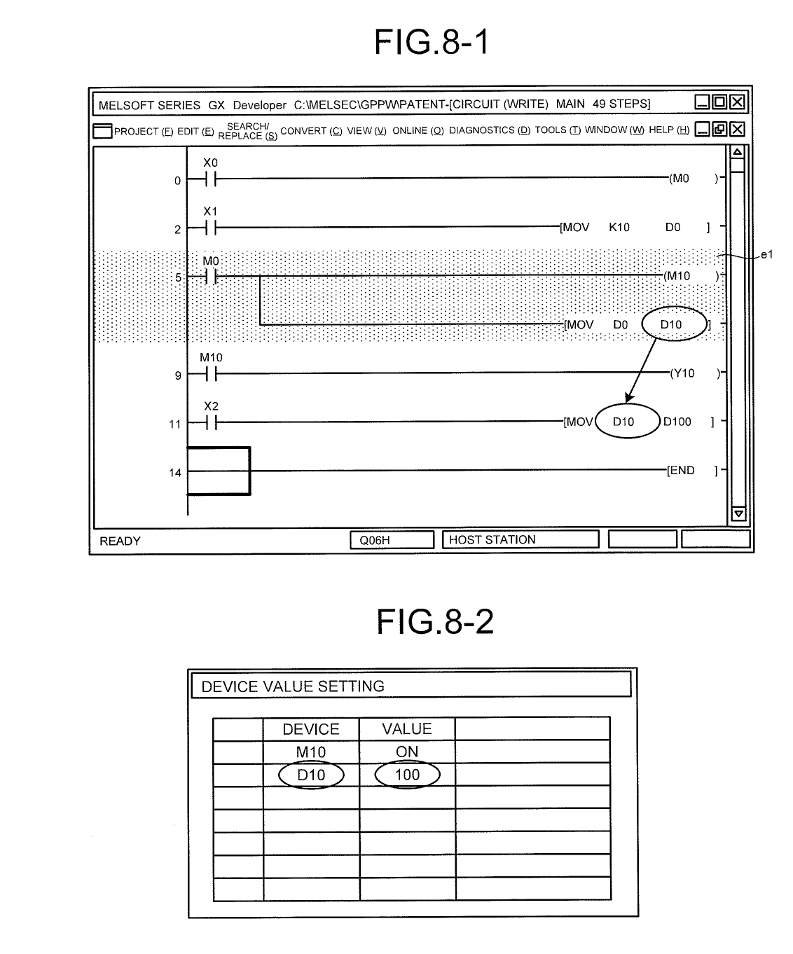

FIG. 8 is a view for explaining a screen when a word device operated in the skipping range is extracted and a value is set therefor. Screens shown in FIGS. 8-1 and 8-2 are created by the screen creating unit 24 and are displayed on the display device 13. In the example shown in FIG. 8-1, the word device D10 is included in a skipping range e1, and further, the word device D10 is referred out of the skipping range e1. Thus, the extracting unit 23 extracts the word device D10.

FIG. 8-2 is a view illustrating a screen to set a value to the extracted word device D10. In the example shown in FIG. 8-2, value “100” is associated with the word device D10. “D10” in the item of device is the word device extracted by the extracting unit 23, and the value input from the input device 11 is displayed in a corresponding value section. Thus, the value setting unit 25 sets value “100” to the word device D10.

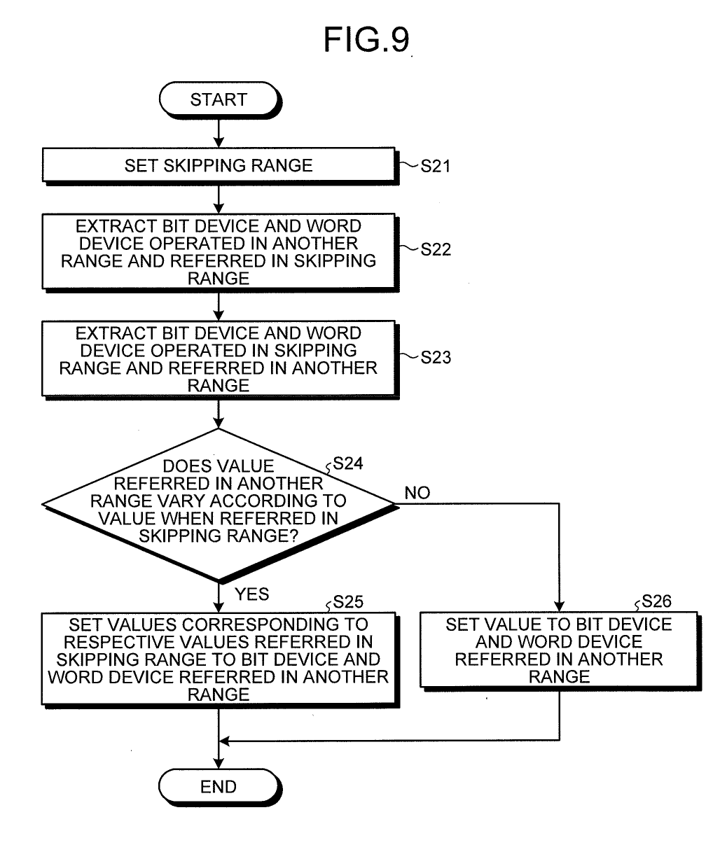

FIG. 9 is a flowchart for explaining process of setting a value to a bit device and a word device that are included in the skipping range and values of which vary according to a value of a bit device or a word device in another range. The processing shown in FIG. 9 is executed by the debugging device 10.

At step S21 shown in FIG. 9, the range setting unit 22 sets a skipping range. At step S22, the extracting unit 23 extracts a bit device and a word device that are operated in another range and referred from the skipping range. At step S23, the extracting unit 23 extracts a bit device and a word device that are operated in the skipping range and are referred in another range.

At step S24, the value setting unit 25 determines whether the value of the device extracted at step S23 is dependent on the value of the device extracted at step S22. When dependent, the process proceeds to step S25, and when not dependent, the process proceeds to step S26.

At step S25, values corresponding to respective values referred in the skipping range are set to the bit device and the word device that are referred in another range. At step S26, values are set to the bit device and the word device that are referred in another range.

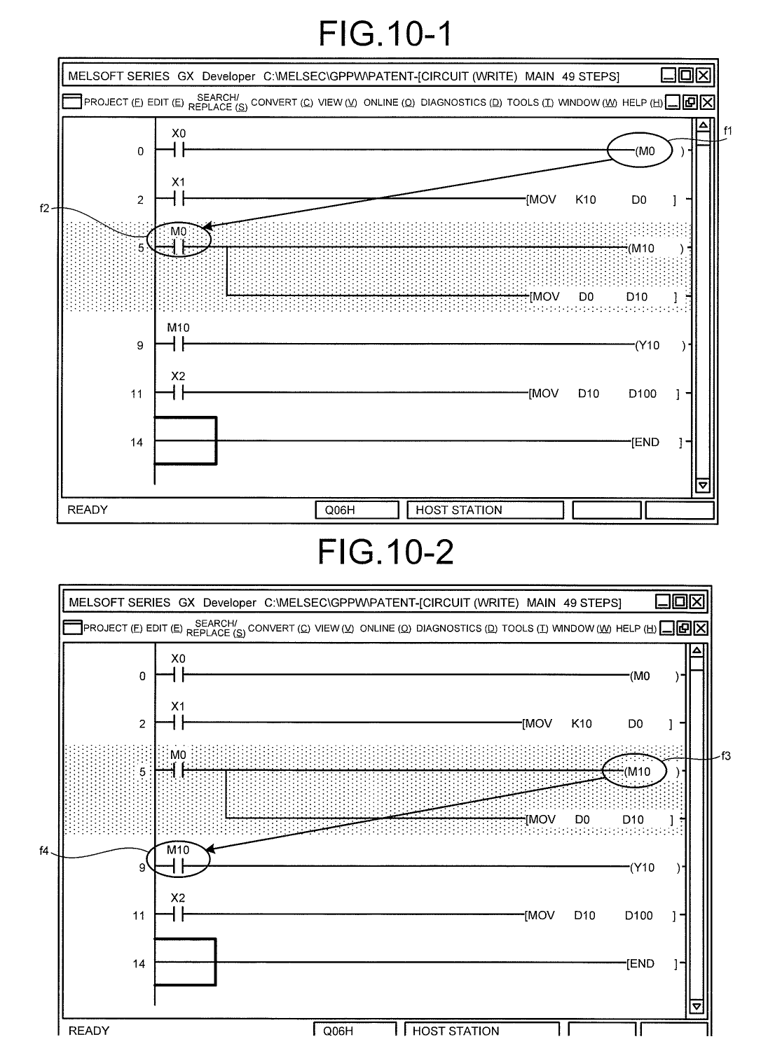

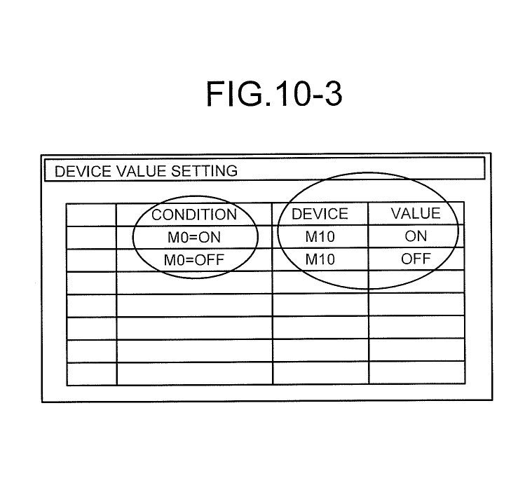

FIGS. 10 to 13 are views illustrating an example of a screen that is displayed when values of a bit device and a word device are set by the processing shown in FIG. 9. Screens shown in FIGS. 10 to 13 are created by the screen creating unit 24.

FIG. 10 is a view illustrating an example of setting a value of a bit device. FIG. 10-1 is a view illustrating an example that a bit device that is operated in another range and is referred in the skipping range is extracted. In the example shown in FIG. 10-1, a bit device M0 output at f1 is input to f2 included in the skipping range.

FIG. 10-2 is a view illustrating an example that a bit device that is operated in the skipping range and is referred in another range is extracted. In the example shown in FIG. 10-2, the bit device M0 output at f3 in the skipping range is input to f4. From FIGS. 10-1 and 10-2, the value of the bit device M0 input to f4 differs according to the value input to f2.

FIG. 10-3 is a view illustrating a screen to set the value of M0 input to f4. In FIG. 10-3, “condition” indicates an item of a value when input to f2, “device” indicates an item of a device name, and “value” indicates an item of a value to be set.

FIG. 10-3 illustrates an example in which a value to be input to f4 is input by the input device 11 for each of the cases in which a value input to f2 is “ON” and is “OFF”. The input value is associated with each condition by the value setting unit 25 and is retained in the data retaining unit 28.

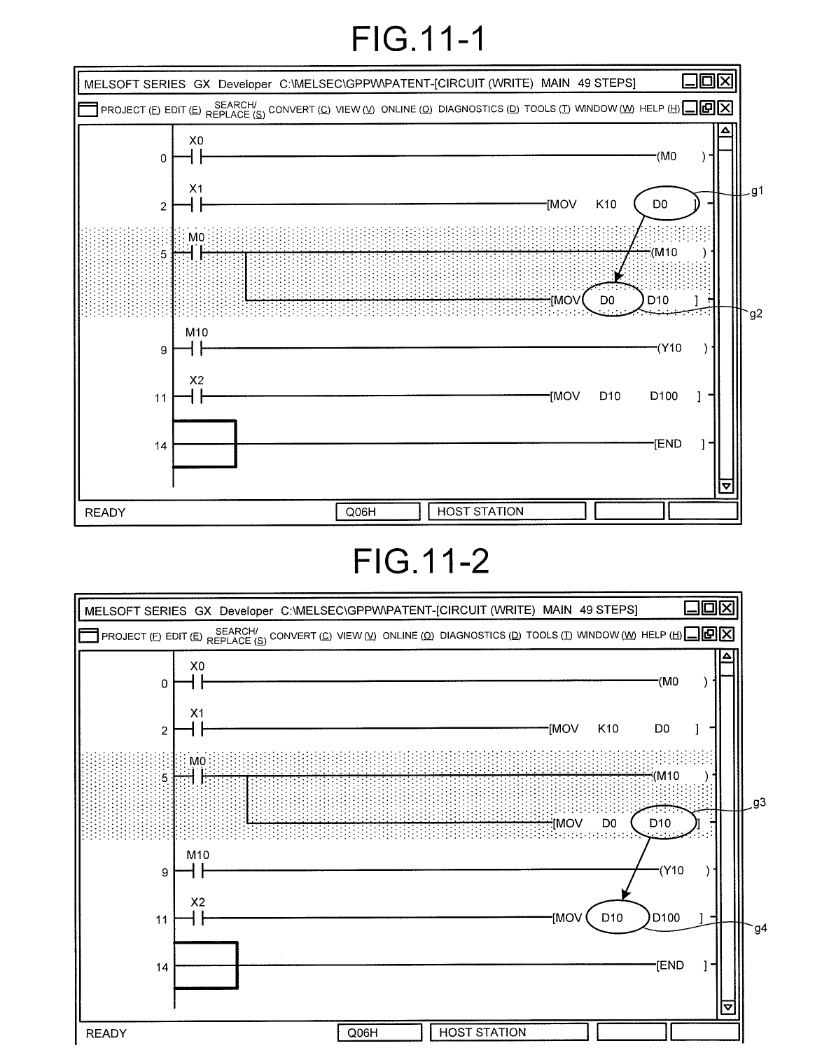

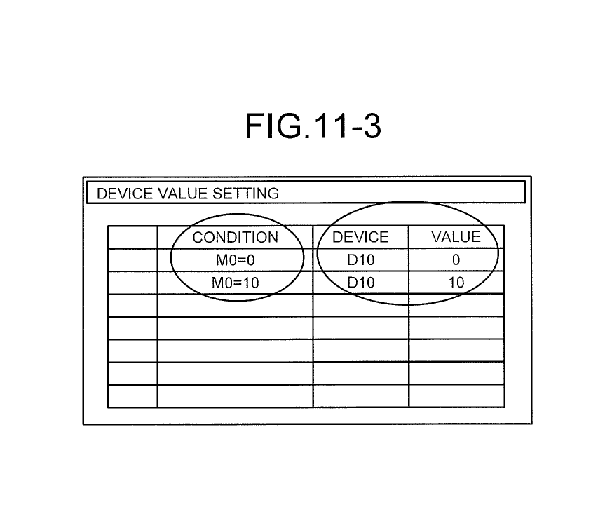

FIG. 11 is a view illustrating an example of setting a value of a word device. FIG. 11-1 is a view illustrating an example that a word device that is operated in another range and is referred in the skipping range is extracted. In the example shown in FIG. 11-1, a word device D0 output at g1 is referred at g2 in the skipping range, and is assigned to the word device D10.

FIG. 11-2 is a view illustrating an example that a word device that is operated in the skipping range and is referred in another range is extracted. In the example shown in FIG. 11-2, the word device D10 output at g3 is referred at g4.

FIG. 11-3 is a view illustrating an example of a screen in which a value of the word device D10 is set for each value of the word device D0 referred at g2. In FIG. 11-3, “condition” indicates an item of a value when referred at g2, “device” indicates an item of a device name to which a value is set, and “value” indicates an item of a value to be set.

In the example shown in FIG. 11-3, a value input to g4 is input by the input device 11 for each of the cases in which the value of the word device D0 input to g2 is “0” and is “10”. The input value is associated with each condition by the value setting unit 25 and is retained in the data retaining unit 28.

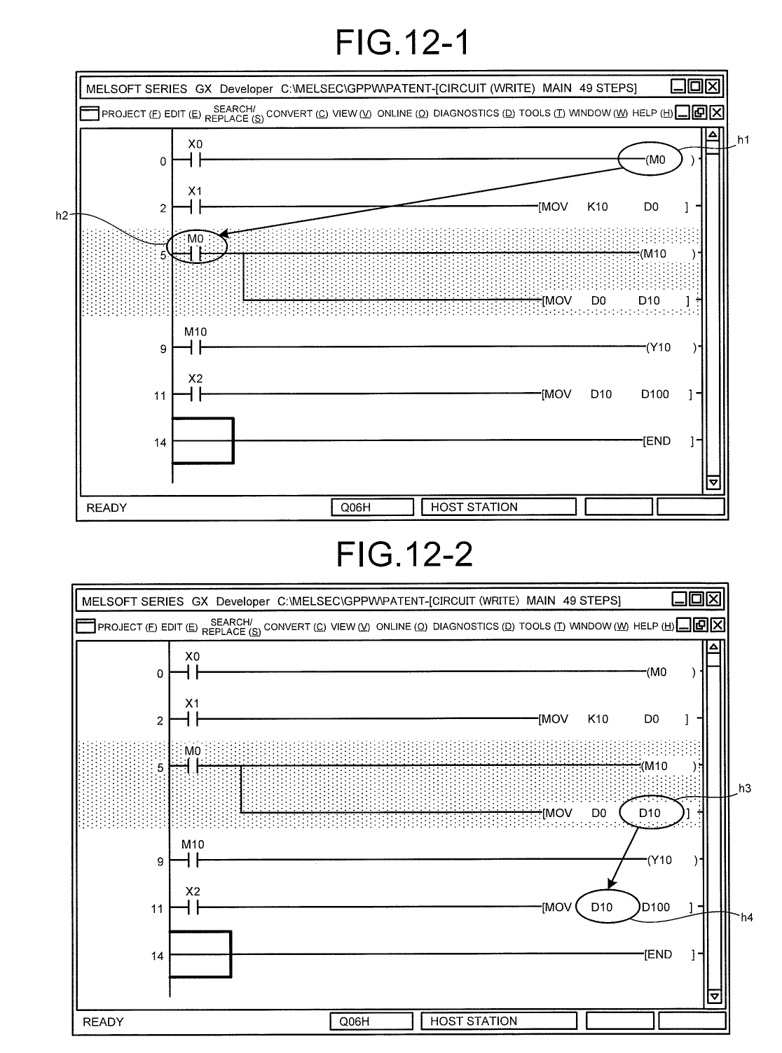

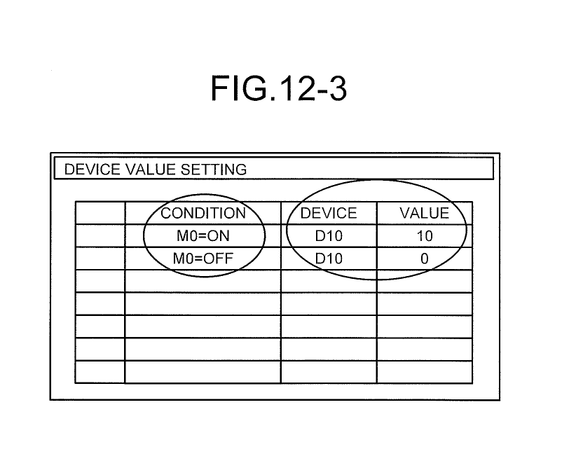

FIG. 12 is a view illustrating an example of setting a value of a word device for each value of a bit device. FIG. 12-1 is a view illustrating an example that a bit device that is operated in another range and is referred in the skipping range is extracted. In the example shown in FIG. 12-1, the bit device M0 output at h1 is referred at h2 included in the skipping range, and based on the value, values of M10 and D10 are operated.

FIG. 12-2 is a view illustrating an example that a word device that is operated in the skipping range and is referred in another range is extracted. In the example shown in FIG. 12-2, the word device D10 output at h3 in the skipping range is referred at h4.

FIG. 12-3 is a view illustrating an example of a screen to set a value of the word device D10 for each value of the bit device M0 that is referred at h2. In FIG. 12-3, “condition” indicates an item of a value of M0 referred at h2, “device” indicates an item of a device name to which a value is set, and “value” indicates an item of a value to be set.

FIG. 12-3 illustrates an example in which a value of D10 input to h4 is input by the input device 11 for each of the cases in which a value of the bit device M0 input to h2 is “ON” and is “OFF”. The input value is associated with each condition by the value setting unit 25 and is retained in the data retaining unit 28.

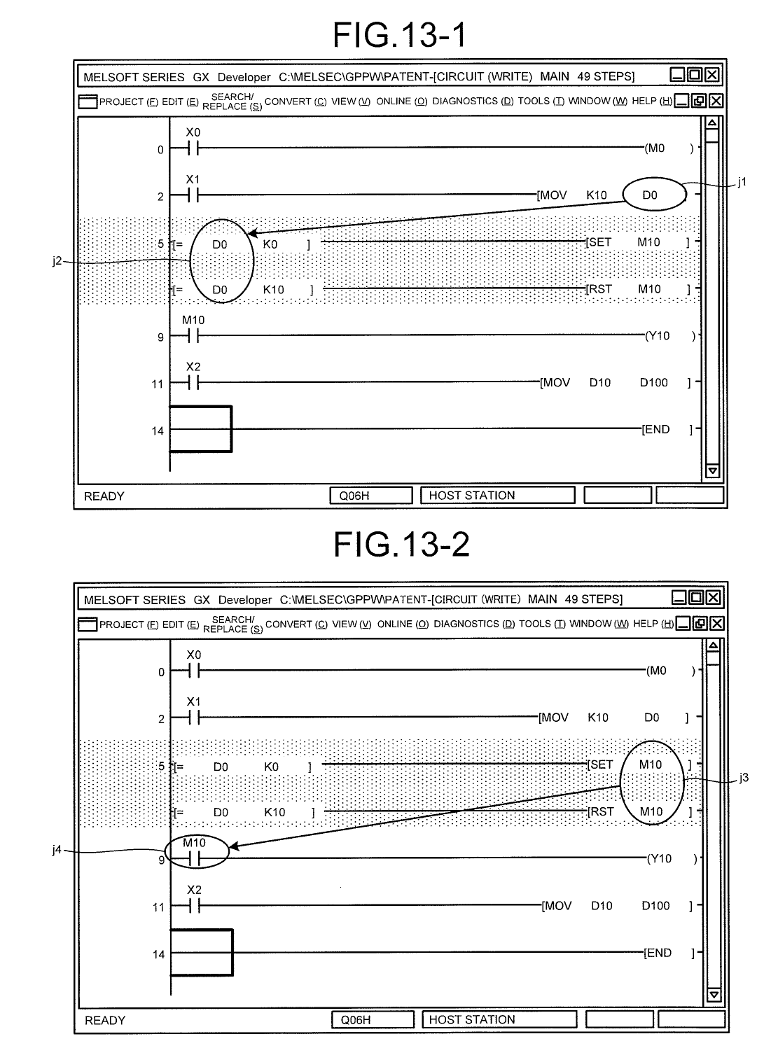

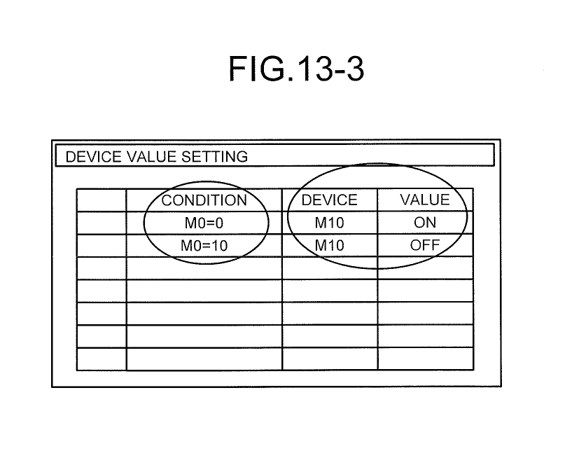

FIG. 13 is a view illustrating an example in which a value of a bit device is set for each value of a word device. FIG. 13-1 is a view illustrating an example that a word device that is operated in another range and is referred in the skipping range is extracted. In the example shown in FIG. 13-1, the word device D0 output at j1 is referred at j2 in the skipping range, and according to the value, the value of the bit device M10 is determined.

FIG. 13-2 is a view illustrating an example that a bit device that is operated in the skipping range and is referred in another range is extracted. In the example shown in FIG. 13-2, the value of the bit device M10 output at j3 in the skipping range is referred at j4.

FIG. 13-3 is a view illustrating an example of a screen to set a value of the bit device M10 for each value of the word device D0 referred at j2. In FIG. 13-3, “condition” indicates an item of a value of D0 referred at j2, “device” indicates an item of a device name to which a value is set, and “value” indicates an item of a value to be set.

FIG. 13-3 illustrates an example in which the value of M10 input to j4 is input by the input device 11 for each of the cases in which the value of the word device D0 input to j2 is “ON” and is “OFF”. The input value is associated with each condition by the value setting unit 25 and is retained in the data retaining unit 28.

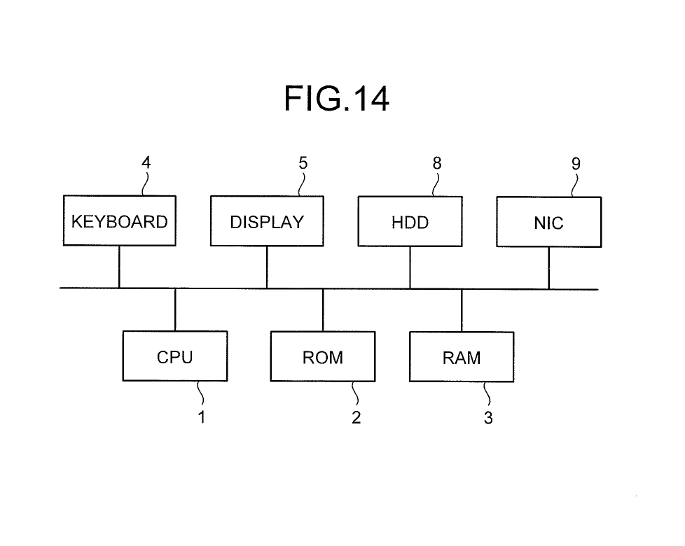

FIG. 14 is a schematic diagram of a hardware configuration of the debugging device 10 according to the present embodiment. The debugging device 10 according to the present embodiment includes a CPU (central processing unit) 1, a ROM (read only memory) 2, a RAM (random access memory) 3, a keyboard 4, a display 5, a hard disk drive (hereinafter, “HDD”) 8, and a network interface card (hereinafter, “NIC”) 9.

The CPU 1 is a control device, and controls various parts of the debugging device 10. The ROM 2 and the RAM 3 are storage devices, and store programs that are executed by the CPU 1 and the like, and also functions as a work memory when the CPU 1 executes a program.

A computer program according to the present embodiment may be stored in a computer-readable recording medium besides being stored in the ROM 2, and be read by the CPU 1 to be executed by being inserted in a not shown driv device and the like.

The keyboard 4 is an input device, and inputs instructions and the like to the debugging device 10. The display 5 is a display device, and displays a screen to show an operator at debugging and the like. The HDD 8 is a storage device, and stores data such as a sequence program to be debugged and a program that is executed by the CPU 1 and the like. The NIC 9 communicates with not shown other devices and the like that are connected thereto through a network.

As above, the exemplary embodiment of the invention has been explained. However, the present invention is not limited to the embodiment described in this exemplary embodiment, and can be modified without departing from the spirit of the present invention.

### INDUSTRIAL APPLICABILITY

As described above, a debugging device according to the present invention is suitable for debugging of a sequence program that is used when an apparatus to be controlled is manufactured.

### REFERENCE SIGNS LIST

1 CPU

2 ROM

3 RAM

4 KEYBOARD

5 DISPLAY

8 HDD

9 NIC

10 DEBUGGING DEVICE

11 INPUT DEVICE

12 CONTROL DEVICE

13 DISPLAY DEVICE

21 SETTING UNIT

22 RANGE SETTING UNIT

23 EXTRACTING UNIT

24 SCREEN CREATING UNIT

25 VALUE SETTING UNIT

28 DATA RETAINING UNIT

29 EXECUTING UNIT

1. A debugging device for a sequence program, comprising:
a range setting unit that sets a skipping range to be skipped when a sequence program is executed;
an extracting unit that extracts an output contact that is included in the skipping range, and that outputs a value to another range; and
a value setting unit that sets a value to the extracted output contact.

2. The debugging device for a sequence program according to claim 1, further comprising a value retaining unit that retains the set value.

3. The debugging device for a sequence program according to claim 1, wherein
the extracting unit further extracts an input contact that is included in a range different from the skipping range, and that inputs a value to the skipping range, and
the value setting unit sets the value of the output contact for each value that can be taken by the input contact, when the value of the output contact varies according to the value of the input contact.

4. The debugging device for a sequence program according to claim 1, further comprising an executing unit that executes a debugging processing for the sequence program using the set value of the output contact.

5. The debugging device for a sequence program according to claim 1, wherein the input contact and the output contact are any one of a bit device and a word device.

6. A debugging method for a sequence program, comprising:
a range setting step of setting a skipping range to be skipped when a sequence program is executed;
an extracting step of extracting an output contact that is included in the skipping range, and that outputs a value to another range; and
a value setting step of setting a value to the extracted output contact.

7. A computer program that makes a computer to execute a debugging method for a sequence program, comprising:
a range setting step of setting a skipping range to be skipped when a sequence program is executed;
an extracting step of extracting an output contact that is included in the skipping range, and that outputs a value to another range; and
a value setting step of setting a value to the extracted output contact.
